(19) United States
(12) Patent Application Publication
(10) Pub. No.: US 2023/0023037 A1
(43) Pub. Date: Jan. 26, 2023

(54) COMPUTER-BASED TECHNIQUES FOR VISUALLY NARRATING RECORDED MEETING CONTENT

(71) Applicant: AUTODESK, INC., San Rafael, CA (US)

(72) Inventors: Bon Adriel ASENIERO, Toronto (CA); George FITZMAURICE, Toronto (CA); Justin Frank MATEJKA, Newmarket (CA); Nicole Barbosa SULTANUM, Toronto (CA)

(21) Appl. No.: 17/671,286

(22) Filed: Feb. 14, 2022

Related U.S. Application Data
(60) Provisional application No. 63/225,330, filed on Jul. 23, 2021.

(51) Int. Cl. G06F 3/04847; G06T 11/20; G06F 3/04817; G10L 17/14; G06F 3/16; G10L 25/57; G06F 40/166

(52) U.S. Cl. CPC G06F 3/04847; G06T 11/206; G06F 3/04817; G10L 17/14; G06F 3/167; G10L 25/57; G06F 40/166

(57) ABSTRACT

In various embodiments, a meeting narration application generates visualizations of recorded meeting data. The meeting narration application generates a first visualization of a set of parameters based on a set of transcript sentences associated with the recorded meeting data. The meeting narration application displays the first visualization and a first expanded content visualization of a first transcript sentence included in the set of transcript sentences within a graphical user interface (GUI). Subsequently, the meeting narration application receives a user event associated with the first visualization via the GUI. The meeting narration application modifies a first parameter selection associated with the set of parameters based on the user event to generate a modified parameter selection. Based on the modified parameter selection, the meeting narration application displays a first compressed content visualization of the first transcript sentence within the GUI.

### CROSS-REFERENCE TO RELATED APPLICATIONS

This application claims priority benefit of the United States Provisional Patent Application titled, “DATA VISUALIZATION TOOL FOR REVISITING RECORDINGS AND TRANSCRIPTS FROM ONLINE MEETINGS,” filed on Jul. 23, 2021 and having Ser. No. 63/225,330. The subject matter of this related application is hereby incorporated herein by reference.

### BACKGROUND

### Field of the Various Embodiments

The various embodiments relate generally to computer science and data visualization software and, more specifically, to computer-based techniques for visually narrating recorded meeting content.

### Description of the Related Art

Many organizations make extensive use of conferencing software to hold audio meetings or video meetings among participants who reside in different locations. Conferencing software is typically configurable to automatically record one or more types of meeting content. Some examples of “meeting content” include, without limitation, shared video content, shared audio content, and shared chat text. Recorded meeting content not only provides opportunities to revisit one or more meetings in order to revisit one or more discussed topics or answer various follow-up questions, but also provides opportunities to detect patterns and trends across collections of meetings or “meeting collections.” These types of patterns and trends can lead to useful insights about substantive topics, participation, attendance, meeting productivity, and other similar issues. In practice, however, exploring recorded meeting content for even a single meeting using conventional software can be challenging, if not impossible. Consequently, opportunities to learn from past meetings or meeting collections can be lost.

One approach to exploring recorded meeting content involves scrubbing audio-video recordings or audio-only recordings of meetings using playback software. In “scrubbing,” the playback software provides a timeline for a recording, and a user manually moves a cursor along the timeline to control playback of the recording. One drawback of scrubbing is that manually identifying relevant audio content across a meeting collection can be prohibitively time-consuming. For example, identifying the different design options for a particular product that were discussed during a relatively large meeting collection could require listening to tens of hours of recordings. Another drawback of scrubbing is that the sheer volume of audio content associated with even one sixty-minute meeting could obfuscate patterns and trends that could lead to useful insights.

Another approach to exploring recorded meeting content involves using a text editor to “look through” meeting transcripts that are automatically generated from audio-video recordings or audio-only recordings of a meeting or meeting collection. One drawback of this approach is that transcripts oftentimes include transcription errors that can result in ambiguities, which can cause confusion about what was being said or discussed in a meeting and, accordingly, lead to incorrect conclusions. Another drawback is that, even if a transcript does not include any significant transcription errors, reviewing a transcript using a conventional text editor to detect useful patterns and trends is primarily a manual and time-consuming process that sometimes provides no useful results.

As the foregoing illustrates, what is needed in the art are more effective techniques for exploring and analyzing recorded meeting content.

### SUMMARY

One embodiment of the present invention sets forth a computer-implemented method for generating visualizations of recorded meeting data, The method includes generating a first visualization of a set of parameters based on a set of transcript sentences associated with the recorded meeting data; displaying the first visualization and a first expanded content visualization of a first transcript sentence included in the set of transcript sentences within a graphical user interface (GUI); receiving a user event associated with the first visualization via the GUI; modifying a first parameter selection associated with the set of parameters based on the user event to generate a modified parameter selection; and displaying a first compressed content visualization of the first transcript sentence within the GUI based on the modified parameter selection.

At least one technical advantage of the disclosed techniques relative to the prior art is that the disclosed techniques enable efficient exploration and analysis of recorded meeting content based on topics, attendees, or other similar parameters. In that regard, with the disclosed techniques, visualizations of transcript sentences displayed within a graphical user interface (GUI) can be automatically collapsed or expanded based on topic selection, attendee selection, or other parameter to interactively filter-out transcript sentences that likely are irrelevant. Further, with the disclosed techniques, because graphical widgets associated with expanded visualizations of transcript sentences enable on-demand playback of corresponding sound bites, ambiguities arising from transcription errors can be efficiently resolved. Another advantage of the disclosed techniques is that visualizations displayed within a GUI can automatically expose potentially relevant patterns and trends across any volume and/or type of media content. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is an illustration of an exemplar screenshot of an initial set of visualizations generated by the meeting narration application of FIG. 1, according to various embodiments;

FIG. 3 is an illustration of an exemplar screenshot of a targeted set of visualizations generated by the meeting narration application of FIG. 1, according to various embodiments; and

FIG. 4 is a flow diagram of method steps for generating visualizations of recorded meeting data, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are denoted with reference numbers identifying the object and parenthetical alphanumeric character(s) identifying the instance where needed.

### System Overview

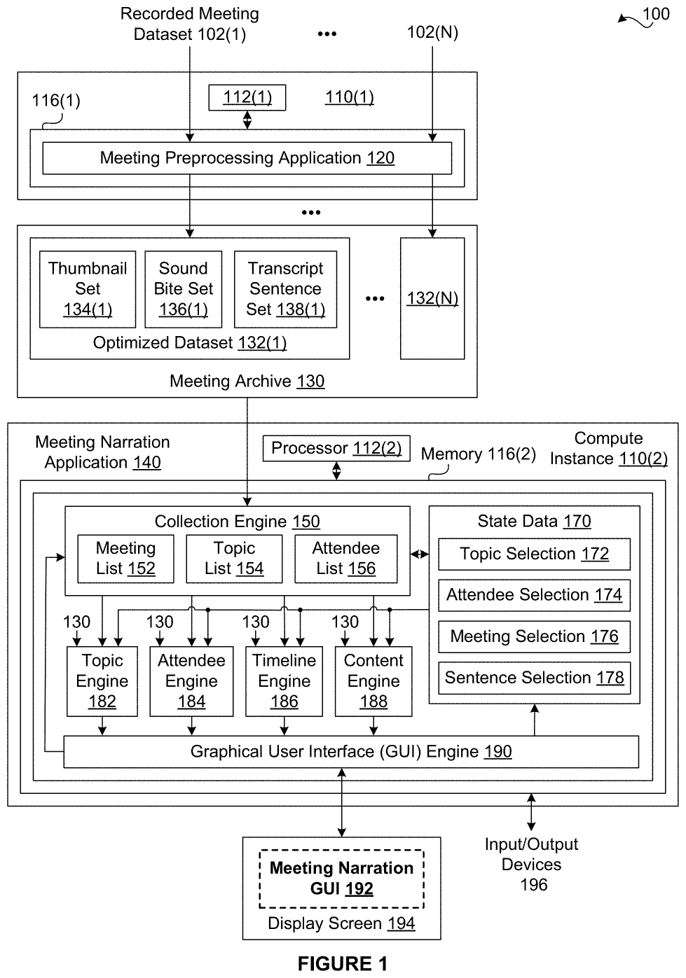

FIG. 1 is a conceptual illustration of a system 100 configured to implement one or more aspects of the various embodiments. As shown, in some embodiments, the system 100 includes, without limitation, a compute instance 110(1), a meeting archive 130, a compute instance 110(2), a display screen 194, and input/output devices 196. In some other embodiments, the system 100 can further include, without limitation, one or more other compute instances, one or more other display screens, or any combination thereof. In some embodiments, any amount and/or types of storage, any amount and/or types of memory, or any combination thereof can supplement or replace the meeting archive 130. In the same or other embodiments, any number of touchscreens can supplement or replace the display screen 194.

Any number of the components of the system 100 can be distributed across multiple geographic locations or implemented in one or more cloud computing environments (e.g., encapsulated shared resources, software, and data) in any combination. For explanatory purposes only, the compute instance 110(1) and the compute instance 110(2) are also referred to herein individually as “the compute instance 110” and collectively as “the compute instances 110.” In some embodiments, each of the compute instances 110 can be implemented in a cloud computing environment, implemented as part of any other distributed computing environment, or implemented in a stand-alone fashion.

As shown, in some embodiments, the compute instance 110(1) includes, without limitation, a processor 112(1) and a memory 116(1). In the same or other embodiments, the compute instance 110(2) includes, without limitation, a processor 112(2) and a memory 116(2). The processor 112(1) and the processor 112(2) are also referred to herein individually as “the processor 112” and collectively as “the processors 112.” The memory 116(1) and the memory 116(2) are also referred to herein individually as “the memory 116” and collectively as “the memories 116.”

Each of the processors 112 can be any instruction execution system, apparatus, or device capable of executing instructions. For example, each of the processors 112 could comprise a central processing unit, a graphics processing unit, a controller, a micro-controller, a state machine, or any combination thereof. The memory 116 of each of the compute instances 110 stores content, such as software applications and data, for use by the processor 112 of the compute instance 110. In some embodiments, each of any number of other compute instances can include any number of other processors and any number of other memories in any combination. In particular, any number of the compute instances 110 (including one) and zero or more other compute instances can provide a multiprocessing environment in any technically feasible fashion.

Each of the memories 116 can be one or more of a readily available memory, such as random-access memory, read only memory, floppy disk, hard disk, or any other form of digital storage, local or remote. In some embodiments, a storage (not shown) can supplement or replace one or more of the memories 116. The storage can include any number and type of external memories that are each accessible to one or more of the processors 112. For example, and without limitation, the storage can include a Secure Digital Card, an external Flash memory, a portable compact disc read-only memory, an optical storage device, a magnetic storage device, or any suitable combination of the foregoing.

As shown, in some embodiments, the compute instance 110(2) is connected to the input/output devices 196. The input/output devices 196 can include, without limitation, one or more devices configured to receive input, one or more devices configured to provide output, one or more devices configured to both receive input and provide output, or any combination thereof. Some examples of devices that can be configured to receive input include, without limitation, a keyboard, a mouse, and a microphone. Some examples of devices that can be configured to provide output include, without limitation, a display device and a speaker. Some examples of devices that can be configured to both receive input and provide output include, without limitation, a touchscreen and a universal serial bus port.

In some embodiments, the input/output devices 196 include, without limitation, at least one device (e.g., a speaker) that can be configured to receive any amount and/or types of audio content from the compute instance 110(2) and, in response, produce sound. In the same or other embodiments, the compute instance 110(2) can configure at least one of the input/output devices 196 to playback, without limitation, any number of audio bytes and/or the audio portions of any number of video clips. In some embodiments, the input/output devices 196 include, without limitation, a display device that can be configured to display any amount and/or types of visual content on the display screen 194 in any technically feasible fashion. For instance, in some embodiments, the input/output devices 196 include, without limitation, a speaker, a display device having the display screen 194, a keyboard, and a mouse.

In some embodiments, the compute instance 110(2) can be integrated with any number and/or types of other devices (e.g., other compute instances and the input/output devices 196) into a user device. Some examples of user devices include, without limitation, desktop computers, laptops, smartphones, smart televisions, game consoles, and tablets.

In general, each of the compute instances 110 is configured to implement one or more software applications. For explanatory purposes only, each software application is described as residing in the memory 116 of one of the compute instances 110 and executing on a processor 112 of the compute instance 110. In some embodiments, any number of instances of any number of software applications can reside in the memories 116 of any number of compute instances 110 and execute on the processors 112 of any number of compute instances 110 in any combination. In the same or other embodiments, the functionality of any number of software applications can be distributed across any number of other software applications that reside in the memories 116 of any number of compute instances 110 and execute on the processors 112 of any number of compute instances 110 in any combination. Further, subsets of the functionality of multiple software applications can be consolidated into a single software application.

In particular, the compute instances 110 are configured to enable interactive exploration of recorded meeting data for collections or sets of meetings referred to herein as “meeting collections.” In some embodiments, each meeting collection includes, without limitation, one or more meetings that can be unrelated or can be related in any technically feasible fashion. In some other embodiments, each meeting collection is a set of one or more related meetings. For instance, in some embodiments, each meeting collection is a set of recorded meetings associated with the same project and/or the same team. Each meeting collection can be specified and/or subsequently modified (e.g., as new meetings are held and recorded) in any technically feasible fashion.

As described previously herein, while conferencing software is typically configurable to automatically record one or more types of meeting content, exploring recorded meeting content for even a single meeting using conventional software can be challenging, if not impossible. Consequently, opportunities to learn from past meetings or meeting collections can be lost. One approach to exploring recorded meeting content involves scrubbing recordings of meetings using playback software. One drawback of scrubbing is that manually identifying relevant audio content across a meeting collection can be prohibitively time-consuming. Another drawback of scrubbing is that the sheer volume of audio content associated with even one sixty-minute meeting could obfuscate patterns and trends that could lead to useful insights.

Another approach to exploring recorded meeting content involves using a text editor to look through meeting transcripts that are automatically generated from recordings of a meeting or meeting collection. One drawback of this approach is that transcripts oftentimes include transcription errors that can result in ambiguities that can lead to incorrect conclusions. Another drawback is that reviewing a transcript using a conventional text editor to detect useful patterns and trends is primarily a manual and time-consuming process that sometimes provides no useful results.

### Visually Narrating Recorded Meeting Content

To address the above problems, in some embodiments, the compute instances 110 include, without limitation, a meeting preprocessing application 120 and a meeting narration application 140. As described in greater detail below, in some embodiments, the meeting preprocessing application 120 preprocesses recorded meeting content for a collection of meetings to generate optimized datasets for the collection of meetings. In some embodiments, the optimized datasets reduce the amount of storage, processing resources, transmission bandwidth, or any combination thereof associated with exploring the recorded meeting content.

As described in greater detail below, in some embodiments, the meeting narration application 140 generates a set of visual representations or “visualizations” of the recorded meeting content for a meeting collection based on the corresponding optimized datasets. Any number of the visualizations included in the set of visualizations can be visualizations of one or more parameters associated with the meeting collection. Some examples of parameters that can be associated with a meeting collection include, without limitation, attendees, topics, meetings, organizations, attendee types, goals, and other similar parameters. In some embodiments, the set of visualizations includes, without limitation, visualizations of topics, attendees, meetings, and transcript sentences. The meeting narration application 140 displays the set of visualizations within a meeting narration GUI 192 that is displayed on the display screen 194

In response to user interactions with interactive graphical components or “graphical widgets” included in or associated with the set of visualizations, the meeting narration application 140 visually narrates an exploration of the recorded meeting content. In some embodiments, in response to the activation of graphical widgets that are time-aligned to visualizations of transcript sentences, the meeting narration application 140 causes the playback of corresponding sound bites and/or corresponding video clips. In the same or other embodiments, in response to user selections of topics, attendees, meetings, zero or more other parameters, or any combination thereof, the meeting narration application 140 modifies and then re-displays the set of visualizations within the meeting narration GUI 192. More specifically, in some embodiments, the meeting narration application 140 modifies the set of visualizations to emphasize recorded meeting content and derived information that is likely to be relevant and/or to filter-out recorded meeting content and derived information that is likely to be irrelevant. Accordingly, the meeting narration application 140 can automatically expose potentially relevant patterns, trends, and relationships across the recorded meeting content.

As persons skilled in the art will recognize, the techniques described herein can be used to customize visualizations of recorded meeting content and any amount and/or types of relevant derived information for a collection of one or more meetings based on user selections of any number of topics, any number of attendees, any number of meetings, any number of other parameters, or any combination thereof. In particular, the content and/or types of visualizations can be altered without departing from the broader spirit and scope of the embodiments.

In some embodiments, any amount of the preprocessing functionality described herein is provided by the meeting narration application 140 instead of the meeting preprocessing application 120. In the same or other embodiments, the meeting preprocessing application 120 is omitted from the system 100. In some embodiments, the system 100 can include, without limitation, zero or more instances of the meeting preprocessing application 120 and one or more instances of the meeting narration application 140.

It will be appreciated that the system shown herein is illustrative and that variations and modifications are possible. Although not shown, in some embodiments, any number of instances of the meeting narration application 140 can visually narrate any number of interactive explorations of recorded meeting content for any number of meeting collections, via the meeting narration GUI 192 and/or one or more other GUIs. In the same or other embodiments, each instance of the meeting narration application 140 can automatically expose potentially relevant patterns, trends, and relationships across any volume and/or types of media content. In some embodiments, the meeting narration GUI 192 and/or each of any number of other GUIs can be displayed on the display screen 194 and/or any number and/or types of other displays screens in any technically feasible fashion.

For explanatory purposes, the functionality provided by the meeting preprocessing application 120 and the meeting narration application 140 are described below in the context of recorded meeting datasets 102(1)-102(N) and optimized datasets 132(1)-132(N), where N can be any integer greater than one. The recorded meeting datasets 102(1)-102(N) are also referred to herein individually as “the recorded meeting dataset 102” and collectively as “the recorded meeting datasets 102.” The optimized datasets 132(1)-132(N) are also referred to herein individually as “the optimized dataset 132” and collectively as “the optimized datasets 132.”

In some embodiments, any amount of recorded meeting content, any amount of “derived information” generated based on the recorded meeting content, and any other types of data included in the recorded meeting datasets 102 and the optimized datasets 132 can be associated with timestamps, time codes, or any other temporal data at any granularity and in any technically feasible fashion. For explanatory purposes, any discrete portion (including all) of meeting content, derived information, or any other type of data is also referred to herein as an “item.”

Associating any amount and/or types of temporal data with any item is referred to herein as “timestamping” the item. In a complementary fashion, any item that is associated with any type of temporal data in any technically feasible fashion is also referred to herein as a “timestamped” item. In some embodiments, a timestamped item can be associated with any number of “time span intervals” in addition to or instead of any number of individual timestamps. In some embodiments, a time span interval corresponds to an interval of time between a start timestamp and an end timestamp.

In some embodiments, any number of timestamps can be embedded in an item. For instance, in some embodiments, timestamps can be embedded in audio content, video content, and transcripts as tags at regular intervals and/or in response to specific events (e.g., a change in speaker and a new sentence). In the same or other embodiments, an item can be associated with any number of externally defined timestamps in any technically feasible fashion. For instance, in some embodiments, any amount and/or types of metadata can specify timestamps for any number of items in any technically feasible fashion. In the same or other embodiments, any amount and/or types of metadata can be timestamped in any technically feasible fashion.

In some embodiments, each recorded meeting dataset 102 is associated with a different recorded meeting. In the same or other embodiments, each recorded meeting dataset 102 includes, without limitation, any amount and/or types of recorded meeting content for the associated recorded meeting and any amount (including none) and/or types of derived information generated based on the recorded meeting content. In some embodiments. In some embodiments, the types and granularity of items included in the recorded meeting datasets 102 do not vary across the recorded meeting datasets 102. In some other embodiments, the types and/or granularity of items included in the recorded meeting datasets 102 vary across the recorded meeting datasets 102.

In some embodiments, each recorded meeting dataset 102 includes, without limitation, a timestamped audio/video recording, any amount (including none) and/or types of metadata, and optionally a timestamped transcript. In the same or other embodiments, each audio/video recording includes, without limitation, timestamped audio content and timestamped video content. Some examples of metadata include, without limitation, timestamps, timestamped speaker identifiers (e.g., names), data associated with attendees of the meeting, screen sharing data, and timestamped chat transcripts. In some embodiments, the transcript. In some embodiments, the transcript includes, without limitation, textual representations of spoken words, optionally any other utterances, and optionally any sound effects, and optionally any sound-based characteristics (e.g., tone of voice).

Each of the recorded meeting datasets 102 can be generated in any technically feasible fashion. In some embodiments, the techniques used to generate the recorded meeting datasets 102 vary across the recorded meeting datasets 102. In some other embodiments, the techniques used to generate the recorded meeting datasets 102 do not vary across the recorded meeting datasets 102.

For instance, in some embodiments, video conferencing software generates the recorded meeting dataset 102(1). In the same or other embodiments, video conferencing software generates an audio/video recording and any amount and/or types of metadata and then stores the audio/video recording and the metadata in the recorded meeting dataset 102(2). Based on the audio/video recording included in the recorded meeting dataset 102(2), transcription software generates a transcript and then stores the transcript in the recorded meeting dataset 102(2).

As shown, in some embodiments, the meeting preprocessing application 120 resides in the memory 116(1) of the compute instance 110(1) and executes on the processor 112(1) of the compute instance 110(1). As described previously herein, in some embodiments, the meeting preprocessing application 120 generates the optimized datasets 132(1)-132(N) based on the recorded meeting datasets 102(1)-102(N), respectively. In the same or other embodiments, the meeting preprocessing application 120 stores the optimized datasets 132(1)-132(N) in the meeting archive 130. The meeting archive 130 can include, without limitation, any number and/or types of memories and/or any amount of storage that is accessible to both the meeting preprocessing application 120 and the meeting narration application 140. In some embodiments, the meeting archive 130 is a database or a datastore.

In some embodiments, the meeting preprocessing application 120 can generate and store (in the meeting archive 130) each of the optimized datasets 132 independently and in response to any type of trigger. For instance, in some embodiments, upon receiving the recorded meeting dataset 102 corresponding to a recorded meeting, the meeting preprocessing application 120 generates the optimized dataset 132 corresponding to the same recorded meeting. In some embodiments, the meeting preprocessing application 120 performs any number and/or types of operations on the recorded meeting dataset 102 to generate the optimized dataset 132 that has reduced storage requirements, reduced processing requirements, reduced transmission requirements, or any combination thereof.

In some embodiments, each of the optimized datasets 132 includes, without limitation, one or more sets of items derived from video content, one or more sets of items derived from audio content, and one or more sets of transcript sentences extracted from a transcript. For instance, in some embodiments, the optimized dataset 132(1) includes, without limitation, a thumbnail set 134(1), a sound bite set 136(1), and a transcript sentence set 138(1) that are derived from the recorded meeting dataset 102(1). Although not shown, in the same or other embodiments, each of the optimized datasets 132(2)-132(N) includes, without limitation, a thumbnail set, a sound bite set, and a transcript sentence set that are derived from the recorded meeting datasets 102(2)-102(N), respectively.

Each thumbnail set (including the thumbnail set 134(1)) includes, without limitation, any number of relatively low resolution thumbnail images that are timestamped in any technically feasible fashion. The meeting preprocessing application 120 can generate each thumbnail set in any technically feasible fashion. In some embodiments, to generate a thumbnail set corresponding to the recorded meeting dataset 102, the meeting preprocessing application 120 samples frames from an audio-video recording or a video-only recording included in the recorded meeting dataset 102. The meeting preprocessing application 120 then extracts timestamped thumbnail images from the sampled video frames and aggregates the timestamped thumbnail images to generate the thumbnail set corresponding to the recorded meeting dataset 102. The meeting preprocessing application 120 can determine a sampling rate in any technically feasible fashion. In some embodiments, the meeting preprocessing application 120 selects a sampling rate (e.g., five seconds) that produces a thumbnail set that can capture visual differences between different speakers in a typical meeting exchange.

Each sound bite set (including the sound bite set 136(1)) includes, without limitation, any number of sound bites. The meeting preprocessing application 120 can generate each sound bite set in any technically feasible fashion. In some embodiments, to generate a sound bite set corresponding to the recorded meeting dataset 102, the meeting preprocessing application 120 extracts sounds bites from the audio content in an audio-video recording or an audio-only recording included in the recorded meeting dataset 102. More specifically, in the same or other embodiments, for each timestamp associated with the transcript included in the recorded meeting dataset 102, the meeting preprocessing application 120 extracts, from the audio content, a sound bite corresponding to one or more transcript sentences that are proximate to the timestamp.

In some embodiments, each transcript sentence set (including the transcript sentence set 138(1)) includes, without limitation, any number of transcript sentences that are each associated with at least a timestamp or a time span interval, a speaker, a video frame, a thumbnail image, and a reduced-resolution version of the thumbnail image. A reduced-resolution version of a thumbnail image is also referred to herein as a “compressed thumbnail image.” The meeting preprocessing application 120 can generate each transcript sentence set in any technically feasible fashion. In some embodiments, to generate a transcript sentence set corresponding to the recorded meeting dataset 102, the meeting preprocessing application 120 determines whether the recorded meeting dataset 102 includes a transcript. If the recorded meeting dataset 102 does not include a transcript, then the meeting preprocessing application 120 generates or configures transcription software (not shown) to generate a transcript based on timestamped audio content and optionally any amount and/or types of metadata included in the recorded meeting dataset 102.

After acquiring the transcript corresponding to the recorded meeting dataset 102, in some embodiments, the meeting preprocessing application 120 splits the transcript text into transcript sentences. Based on timestamps associated with the transcript and optionally any amount and/or types of metadata included in the recorded meeting dataset 102, the meeting preprocessing application 120 associates each of the transcript sentences with either a timestamp or a time span interval, a speaker, and thumbnail image, and a compressed thumbnail image. For each transcript sentence, the meeting preprocessing application 120 can determine a corresponding speaker, a corresponding video frame, a corresponding thumbnail image, and a corresponding compressed thumbnail image in any technically feasible fashion.

In some embodiments, the meeting preprocessing application 120 determines the speaker corresponding to each transcript sentence based on timestamped speaker metadata included in the transcript and/or timestamped speaker metadata included in the recorded meeting dataset 102. In the same or other embodiments, the meeting preprocessing application 120 identifies the corresponding thumbnail image for each transcript sentence as the thumbnail image in the corresponding thumbnail set having the timestamp that is closest to the average timestamp of the transcript sentence.

The meeting preprocessing application 120 can generate the compressed thumbnail image for each transcript sentence in any technically feasible fashion. In some embodiments, for each of the transcript sentences, the meeting preprocessing application 120 reduces the resolution of the corresponding thumbnail image to generate the corresponding compressed thumbnail image. In some other embodiments, for each of the transcript sentences, the meeting preprocessing application 120 sets the corresponding compressed thumbnail image equal to a relatively small block of pixels having the average color of the corresponding thumbnail image.

The meeting preprocessing application 120 can associate each transcript sentence with the corresponding speaker, the corresponding thumbnail image, and the corresponding compressed thumbnail image in any technically feasible fashion. For instance, in some embodiments, the meeting preprocessing application 120 can attach or annotate one or more tags specifying one or more of the corresponding speaker, the corresponding thumbnail image, and the corresponding compressed thumbnail image to each transcript sentence. In the same or other embodiments, the meeting preprocessing application 120 can generate metadata that associates one or more of the corresponding speaker, the corresponding thumbnail image, and the corresponding compressed thumbnail image to each transcript sentence and store the metadata in the optimized dataset 132.

As shown, in some embodiments, the meeting narration application 140 resides in the memory 116(2) of the compute instance 110(2) and executes on the processor 112(2) of the compute instance 110(2). As described previously herein, in some embodiments, the meeting narration application 140 visually narrates an interactive explorations of a meeting collection. For explanatory purposes, the functionality of the meeting narration application 140 is described below in the context of a meeting collection that includes, without limitation, a subset of the N meetings for which recorded meeting data is stored in the recorded meeting datasets 102(1)-102(N). The meeting collection can be defined in any technically feasible fashion. Although not shown, in some embodiments, the meeting narration application 140 or another software application displays one or more visualizations within the meeting narration GUI 192 that allow users to group any number of the meetings corresponding to the optimized datasets 132 into any number of meeting collections.

Although not shown, in some embodiments, the meeting narration application 140 and/or or any number of other software applications can store any amount and/or types of “collection” data and/or any amount and/or types of “session” data in any technically feasible fashion (e.g., in the meeting archive 130) and at any number of points-in-time. As referred to herein, “collection” data includes, without limitation, any amount and/or types of data associated with any number of meeting collections. In a complementary fashion, “session” data includes, without limitation, any amount and/or types of data associated with any number and/or types of interactive explorations of any number of meeting collections. Subsequently, the meeting narration application 140 can retrieve any amount and/or types of stored collection data and/or stored session data to initiate or resume any number of interactive explorations of any number of meeting collections.

As shown, in some embodiments, the meeting narration application 140 includes, without limitation, a collection engine 150, state data 170, a topic engine 182, an attendee engine 184, a timeline engine 186, a content engine 188, and a GUI engine 190. In the same or other embodiments, the collection engine 150 orchestrates an interactive exploration of a meeting collection based on the optimized datasets 132 associated with the meeting collection. As described previously herein, a meeting collection can be defined in any technically feasible fashion.

In some embodiments, to initiate an exploration of a meeting collection, the collection engine 150 generates any number of parameter lists and state data 170. Each parameter list specifies, without limitation, zero or more parameters. In some embodiments, each parameter list is associated with a different parameter type. Some examples of parameter types include, without limitation, topic, attendee, and meeting. The collection engine 150 can generate parameter lists in any technically feasible fashion based on any amount and/or type of data that is associated with the meeting collection. In some embodiments, the collection engine 150 generates parameter list based on the optimized datasets 132 and optionally the recorded meeting datasets 102.

As shown, in some embodiments, the parameter lists include, without limitation, a meeting list 152, a topic list 154, and an attendee list 156. In some embodiments, the meeting list 152 identifies, without limitation, each meeting that is included in the meeting collection. In the same or other embodiments, the topic list 154 specifies, without limitation, any number and/or types of topics that are likely to be important to the meeting collection and, for each topic, zero or more different inflections of the topic. In the same or other embodiments, each topic can be any word (including named entities). In some embodiments, the attendee list 156 specifies, without limitation, each person that attended at least a portion of one meeting included in the meeting list 152. In some other embodiments, the attendee list 156 specifies, without limitation, each attendee that spoke during at least one meeting included in the meeting list 152. The collection engine 150 can determine the meeting list 152, the topic list 154, and the attendee list 156 in any technically feasible fashion.

In some embodiments, the collection engine 150 automatically generates the topic list 154 based on the optimized datasets 132 associated with the meeting collection. The collection engine 150 can automatically generate the topic list 154 in any technically feasible fashion. In some embodiments, the collection engine 150 computes frequencies of terms occurring in the transcript sentences associated with the meeting collection and optionally frequencies of terms occurring in a reference corpus to determine the topic list 154.

For instance, in some embodiments, the collection engine 150 executes one or more term frequency-inverse document frequency (TF-IDF) algorithms based on the optimized datasets 132 to determine topics for the meeting collection. For instance, in some embodiments, the collection engine 150 computes TF-IDF values of an initial set of words in the transcript sentences associated with the meeting collection. The collection engine 150 then ranks the words based on the TF-IDF values, and designates any number of the highest-ranked words as the topics for the meeting collection.

As used herein, the “transcript sentences associated with the meeting collection” refers to the union of the transcript sentence sets included in the optimized datasets 132 associated with the meeting collection. Accordingly, the transcript sentences associated with the meeting collection are, collectively, a textual representation of the words spoken during the recorded meetings included in the meeting collection.

The collection engine 150 can determine the initial set of words and compute the TF-IDF values in any technically feasible fashion. In some embodiments, the collection engine 150 sets the initial set of words equal to the set of all unique words that appear in any transcript text included in any of the optimized datasets 132 associated with the meeting collection. In some other embodiments, the collection engine 150 merges a list of named entities and a list of keywords to generate the initial set of words.

In some embodiments, the collection engine 150 computes the TF-IDF values of the initial set of words in the transcript sentences associated with the meeting collection relative to a sizable reference corpus (e.g., an online encyclopedia). As a result, each TF-IDF value reflects both the frequency of the corresponding word in the transcript sentences and the scarcity of the corresponding word in the reference corpus. Accordingly, in some embodiments, the highest-ranking words that the collection engine 150 designates as the topics for the meeting session are both relatively frequent in the transcript sentences and relatively scarce in the reference corpus.

In some embodiments, the collection engine 150 executes one or more word normalization algorithms and/or text normalization algorithms to determine zero or more inflections of each topic. For instance, in some embodiments the collection engine 150 executes a stemming algorithm on each of the topics to determine a corresponding word stem. For each topic, the collection engine 150 performs any number of search operations on the transcript sentences associated with the meeting collection to identify zero or more inflections of the topic based on the word stem. Subsequently, the collection engine 150 generates the topic list 154 based on the topics and the corresponding inflections.

The collection engine 150 can determine the attendee list 156 in any technically feasible fashion. In some embodiments, the collection engine 150 identifies each person that spoke during at least one recorded meeting included in the meeting collection based on the transcript sentences associated with the meeting collection. The collection engine 150 then sets the attendee list 156 equal to a list of the identified persons. Although not shown, in some other embodiments, the collection engine 150 determines the attendee list 156 based on any amount and/or types of metadata included in the recorded meeting datasets 102 associated with the collection of meetings and/or the optimized datasets 132 associated with the collection of meetings.

In some embodiments, the collection engine 150 defines the scope of and/or customizes the interactive exploration of the collection of meetings based, at least in part, on user input received via the meeting narration GUI 192. In the same or other embodiments, the state data 170 reflects a state of the interactive exploration of the collection of meetings. In some embodiments, state data 170 includes, without limitation, a different selection for each of any number of the parameter lists. A selection for a parameter list is also referred to herein as a “parameter selection.” In some embodiments, a parameter selection specifies, without limitation, zero or more of the parameters included in an associated parameter list and optionally any amount and/or types of data for each specified parameter. For each of the parameter selections, the collection engine 150 can determine and enforce any number and/or types of constraints in any technically feasible fashion. For instance, in some embodiments, the collection engine 150 can enforce a maximum number of “selected” or “target” parameters that can be specified in a given parameter list.

As shown, in some embodiments, the state data 170 includes, without limitation, a topic selection 172, an attendee selection 174, a meeting selection 176, and a sentence selection 178. In some embodiments, the topic selection 172 specifies zero or more topics and optionally specifies a topic/color mapping. The topic/color mapping specifies, without limitation, a different color for each specified topic. In the same or other embodiments, the attendee selection 174 specifies none or one of the attendees. In some embodiments, the meeting selection specifies one or more meetings. In some embodiments, the sentence selection 178 specifies none or one of the transcript sentences associated with the meeting collection.

For explanatory purposes, topics specified in the topic selection 172 are also referred to individually herein as “target topic” and collectively as “target topics.” If an attendee is specified in the attendee selection 174, the attendee is also referred to herein as a “target attendee.” Meetings specified in the meeting selection 176 are also referred to individually herein as “target meeting” and collectively as “target meetings.”

In some embodiments, the acceptable value(s) for the topic selection 172, the attendee selection 174, the meeting selection 176, the sentence selection 178, or any combination thereof can vary and the techniques described herein are modified accordingly. In the same or other embodiments, the state data 170 can include any number and/or types of data instead of or in addition to the topic selection 172, the attendee selection 174, the meeting selection 176, the sentence selection 178, or any combination thereof, and the techniques described herein are modified accordingly.

The collection engine 150 can initialize the state data 170 in any technically feasible fashion. In some embodiments, the collection engine 150 initializes the state data 170 to reflect an initial state of exploration of the meeting collection. In the same or other embodiments, the initial state corresponds to an overview of the topics, an overview of the attendees, and a per-sentence view of the transcript of the last meeting included in the meeting collection. More specifically, in some embodiments, the collection engine 150 initializes the topic selection 172 to specify zero topics, the attendee selection 174 to none, and the meeting selection 176 to specify the most recent meeting from the meeting list 152.

After initializing the state data 170, in some embodiments, the collection engine 150 generates and/or causes the generation of a set of visualizations based on the state data 170, the transcript sentences, any amount and/or types of other data, or any combination thereof. The collection engine 150 can generate and/or cause the generation of each visualization in any technically feasible fashion. As shown, in some embodiments, the collection engine 150 causes the topic engine 182, the attendee engine 184, the timeline engine 186, and the content engine 188 to collectively generate the set of visualizations based on the meeting archive 130, the meeting list 152, the topic list 154, the attendee list 156, and the state data 170.

The set of visualizations can include, without limitation, any number and/or types of visualizations. In some embodiments, a visualization can include, without limitation, one or more graphical components that can each represent any amount and/or types of items included in and/or derived from the optimized datasets 132 and optionally the recorded meeting datasets 102, a hierarchy of one or more other visualizations, or any combination thereof. In some embodiments, each visualization can reflect any portion (including none or all) of the state data 170. Some examples of types of visualizations include, without limitation, thumbnail images, sparklines, bar charts, timelines, panes, and multi-paned windows.

As described in greater detail below, the GUI engine 190 displays the set of visualizations within the meeting narration GUI 192. As used herein “displaying” a visualization or a set of visualizations within a GUI refers to causing visible portion(s) (including none or all) of the visualization or the set of visualizations to be displayed within the GUI on a display screen. In some embodiments, the meeting narration GUI 192 is displayed on the display screen 194 and therefore displaying the set of visualizations within the meeting narration GUI 192 causes any portion (including none or all) of each of the visualizations included in the set of visualizations to be displayed on the display screen 194.

In some embodiments, any number of the graphical components included in a visualization can be graphical widgets. In the same or other embodiments, any number of graphical widgets can be associated with a visualization in any technically feasible fashion. Each graphical widget enables one or more types of user interactions that automatically trigger corresponding user events. Some examples of types of graphical widgets include, without limitation, scroll bars, buttons, clickable playback links, text entry boxes, drop-down lists, and sliders.

In some embodiments, in response to each user event, the meeting narration application 140 and/or any number of components within the meeting narration application 140 can automatically perform and/or cause any other software applications to perform any number and/or types of actions. In the same or other embodiments, in response to various types of user events associated with the set of visualizations, the meeting narration application 140 can playback a sound bite or a video clip, update the state data 170, update any number of parameter lists, update the set of visualizations, or any combination thereof.

As shown, in some embodiments, the GUI engine 190, the collection engine 150, the topic engine 182, the attendee engine 184, the timeline engine 186, the content engine 188, or any combination thereof can automatically perform any number and/or types of actions in response to each user event. In some embodiments, in response to various types of user events associated with the set of visualizations, the collection engine 150 can playback a sound bite or a video clip, update the state data 170, update the topic list 154, update the attendee list 156, cause one or more of the topic engine 182, the attendee engine 184, the timeline engine 186, and the content engine 188 to update the set of visualizations, or any combination thereof.

As shown, in some embodiments, the topic engine 182 generates one or more visualizations of the topics based on the meeting archive 130, the meeting list 152, the topic list 154, and the state data 170. More specifically, the topic engine 182 initially generates and can subsequently re-generate and/or update a top-level visualization of the topics that is referred to herein as a “topic pane.” In some embodiments, the topic engine 182 colors textual representations of the target topic (including any inflections) as per the topic/color mapping.

In some embodiments, the topic pane includes, without limitation, a search sub-pane and a sparkline sub-pane. In the same or other embodiments, the search sub-pane includes, without limitation, any number and/or types of graphical widgets that collectively allow a user to select one or more of the topics in the topic list 154, specify and select any number of new topics, deselect any currently selected topics, or any combination thereof. In the same or other embodiments, in response to user events corresponding to interactions with the search sub-pane, the collection engine 150 modifies the topic list 154 and/or the topic selection 172. The collection engine 150 then causes the topic engine 182, the attendee engine 184, the timeline engine 186, and the content engine 188 to collectively update the set of visualizations in accordance with the modifications.

In some embodiments, the sparkline sub-pane includes, without limitation, a different sparkline for each topic included in the topic list 154. Each of the sparklines indicates the relative prevalence of the associated topic with respect to the meeting collection over time. In some embodiments, to initially generate the sparkline sub-pane, the topic engine 182 generates a different sparkline for each topic in the topic list 154 based on the transcript sentences associated with the meeting collection. In the same or other embodiments, if a new topic is subsequently added to the topic list 154, then the topic engine 182 generates a new sparkline for the new topic based on the transcript sentences associated with the meeting collection. In some embodiments, the topic engine 182 orders the sparklines within the sparkline sub-pane based on the relative frequencies with which the corresponding topics (including any inflections) occur in the transcript sentences. In some embodiments, each sparkline can be replaced with any type of chart or other visualization that depicts the relative prevalence of the associated topic with respect to the meeting collection over time.

As shown, the attendee engine 184 generates one or more visualizations of the attendees based on the meeting archive 130, the meeting list 152, the topic list 154, the attendee list 156, and the state data 170. More specifically, the attendee engine 184 initially generates and can subsequently re-generate and/or update a top-level visualization of the attendees that is referred to herein as an “attendee pane.” In some embodiments, the attendee pane includes, without limitation, an interactive bar chart.

In some embodiments, the interactive bar chart includes, without limitation, a different section for each of the attendees. Each of the sections includes, without limitation, an interactive label specifying the name of the corresponding attendee, one or more bars, and optionally any amount and/or type of relevant data. In some embodiments, the interactive labels collectively form a toggle-based selection mechanism that allows a user to select at most one of the attendees at any given time. In the same or other embodiments, in response to user events corresponding to interactive labels, the collection engine 150 modifies the attendee selection 174. The collection engine 150 then causes the topic engine 182, the attendee engine 184, the timeline engine 186, and the content engine 188 to collectively update the set of visualizations in accordance with the modification to the attendee selection 174.

In some embodiments, if no target topics are specified, then the attendee engine 184 computes the total speaking time of each attendee specified in the attendee list 156 based on the transcript sentences associated with the meeting collection. The attendee engine 184 then maps the total speaking time of each of the attendees to a different uncolored bar and adds the uncolored bar to the corresponding section of the interactive bar chart. In some embodiments, the attendee engine 184 orders the sections in the interactive bar chart based on the lengths of the uncolored bars.

In the same or other embodiments, if at least one target topic is specified, then the attendee engine 184 computes the per-topic speaking time of each attendee with respect to each target topic based on the transcript sentences associated with the meeting collection. The attendee engine 184 then maps the per-topic speaking time(s) of each of the attendees to a different colored bar in accordance with the topic/color mapping. The attendee engine 184 then adds the color bar(s) to the corresponding section of the interactive bar chart. In some embodiments, the attendee engine 184 orders the sections in the interactive bar chart based on the aggregate lengths of the colored bar(s) in each section.

In some embodiments, the timeline engine 186 generates a timeline, a temporal word cloud that is aligned to the timeline, and a top-level visualization of meetings that is aligned to the timeline based on the meeting archive 130, the meeting list 152, and the state data 170. The timeline engine 186 initially generates a linear timeline that spans at least from the start of the earliest meeting in the meeting collection to the end of the last meeting in the meeting collection. The timeline engine 186 initially generates and can subsequently re-generate and/or update the temporal word cloud and the top-level visualization of meetings. The top-level visualization of meetings is also referred to herein as a “meeting pane.”

The temporal word cloud is a visualization that includes, without limitation, topics that are prominent in the transcript sentences during periods of time that are aligned to the visualization of the timeline. In some embodiments, the repetition of a topic within the temporal word cloud indicates that the topic has sustained prominence in the meeting collection over time. The timeline engine 186 can generate and subsequently re-generate and/or modify the temporal word cloud in any technically feasible fashion.

In some embodiments, if no target topics are specified, then the timeline engine 186 depicts the topics included in the temporal word cloud in greyscale. Otherwise, for each target topic, the timeline engine 186 depicts the target topic and any temporally co-occurring topics included in the temporal word cloud in shades of the color assigned to the target topic via the topic/color mapping. If the timeline engine 186 determines that a non-target topic co-occurs with more than one target topic, then the timeline engine 186 depicts the non-target topic in a shade of the color assigned to the target topic having the higher rate of co-occurrence with the non-target topic.

In some embodiments, the meeting pane includes, without limitation, an interactive bar chart. The timeline engine 186 can generate and subsequently re-generate and/or modify the interactive bar chart in any technically feasible fashion. In some embodiments, if a target attendee is specified, then the timeline engine 186 selects each meeting included in the meeting list 152 at which the target attendee spoke (as per the transcript sentence sets included in the optimized datasets 132). Otherwise, the timeline engine 186 selects all the meetings included in the meeting list 152.

For each selected meeting, the timeline engine 186 computes a transcript length and a time span based on the transcript sentence set included in the optimized dataset 132 corresponding to the identified meeting. For each selected meeting, the timeline engine 186 maps the corresponding transcript length to a clickable bar that is temporally-aligned to the timeline based on the corresponding time span. In some embodiments, for each target topic, the timeline engine 186 superimposes strips colored in accordance with the topic/color mapping over the clickable bars to indicate occurrences of the target topic within the transcript sentences.

In some embodiments, each clickable bar is an interactive toggle mechanism that alternately selects and deselects the corresponding meeting. In response to user events corresponding to clickable bars included in the interactive bar chart, the collection engine 150 modifies the meeting selection 176. In the same or other embodiments, the collection engine 150 then causes the content engine 188 to update one or more visualizations included in the set of visualizations in accordance with the modification to the meeting selection 176.

As shown, the content engine 188 generates one or more visualizations of meeting content based on the meeting archive 130, the meeting list 152, the topic list 154, and the state data 170. More specifically, the content engine 188 initially generates and can subsequently re-generate and/or update a top-level visualization of the content that is referred to herein as a “content pane.” The content engine 188 defines the scope of the content to be depicted via the content pane based on the topic selection 172, the attendee selection 174, and the meeting selection 176.

In some embodiments, if any target topics are specified via the topic selection 172 and/or no target meetings are specified, then the content engine 188 sets a target subset equal to the subset of the optimized datasets 132 that correspond to the meeting list 152. Otherwise, the content engine 188 sets a target subset equal to the subset of optimized datasets 132 that correspond to the one or more target meetings.

In some embodiments, the content engine 188 selects the transcript sentences corresponding to the target subset. If no target topics are selected and no target attendee is selected, then the content engine 188 classifies each of the selected transcript sentences as related. Otherwise, if no target topics are selected and a target attendee is selected, then the content engine 188 classifies each selected transcript sentence that is spoken by the target attendee as related. Otherwise, if at least one target topic is selected and no attendee is selected, then the content engine 188 classifies each of the selected transcript sentences that includes at least one of the selected target topics (or corresponding inflections) as related. Otherwise, the content engine 188 classifies each of the selected transcript sentences that is both spoken by the target attendee and includes at least one of the selected target topics (or corresponding inflections) as related. In some embodiments, the content engine 188 then classifies each selected transcript sentence that is temporally adjacent to a “related” transcript sentence associated with the same meeting as “contextual.”

In some embodiments, the content engine 188 generates a standard-sized expanded content visualization for each of the related transcript sentence, a reduced-sized expanded content visualization for each of the contextual transcript sentences, and a compressed content visualization for each of the remaining selected transcript sentences. Within the content pane, the content engine 188 orders the visualizations of the selected transcript sentences based on the corresponding timestamps. If the selected transcript sentences span more than one meeting, then the content engine 188 visually denotes transitions between meetings in any technically feasible fashion.

In the same or other embodiments, the content engine 188 generates an overview scroll bar. For each target topic, the content engine 188 annotates the scroll bar with a set of relatively small objects (e.g., dots and squares) that are colored in accordance with the topic/color mapping. The sets of colored objects provide an temporally-ordered overview of the concurrences of target topic(s) (or corresponding inflections) over the meeting collection.

In general, the expanded content visualizations highlight information that is relevant to the current exploration state (corresponding to the state data 170), while the compressed content visualizations hide or filter information that is irrelevant to the current exploration state. The content engine 188 can generate each expanded content visualization and each compressed content visualization in any technically feasible fashion based on the optimized datasets 132 and/or the recorded meeting datasets 102.

In some embodiments, each expanded content visualization includes, without limitation, a textual representation of the corresponding transcript sentence, a textual representation of the name of the corresponding speaker, a textual representation of a corresponding timestamp, the corresponding thumbnail image, and a playback widget that is associated with a corresponding sound bite or video clip. In some embodiments, within each textual representation of a transcript sentence, the content engine 188 colors occurrences of target topic (and any corresponding inflections) as per the topic/color mapping.

In some embodiments, each of the playback widgets can be any type of graphical widget that can be activated (e.g., clicked) in any technically feasible fashion. In some embodiments, in response to a user event corresponding to an activation of a playback widget, the collection engine 150 causes the playback of the corresponding sound bit or video clip in any technically feasible fashion.

The content engine 188 can generate and/or identify any type of compressed content visualization for an unrelated transcript sentence in any technically feasible fashion. In some embodiments, the content engine 188 sets the compressed content visualization for each of the unrelated transcript sentences equal to the compressed thumbnail image of the unrelated transcript sentence. In the same or other embodiments, the content engine 188 identifies a compressed content visualization of an unrelated transcript sentence from a set of compressed content visualizations based on one or more timestamps associated with the unrelated transcript sentence. In some embodiments, the meeting preprocessing application 120, the content engine 188, any other component of any software application, or any combination thereof can generate a set of compressed content visualizations in any technically feasible fashion.

In some embodiments, variations in the colors of the compressed thumbnail images can provide visual indications of speaker transitions. In some embodiments, the content engine 188 can pack multiple compressed content visualizations into a smaller area of the content pane than any reduced-sized expanded content visualization.

In some embodiments, the GUI engine 190 performs any number and/or types of operations to display the set of visualizations within the meeting narration GUI 192, respond to user events received via the meeting narration GUI 192, and update the display of the set of visualizations within the meeting narration GUI 192. In some embodiments, the GUI engine 190 can cause any other software application to display the set of visualizations within the meeting narration GUI 192. In the same or other embodiments, the GUI engine 190 can cause any other component of the meeting narration application 140 or any other software application to respond to one or more events received via the meeting narration GUI 192. For instance, in some embodiments, the meeting narration GUI 192 can relay any number and/or types of user events to the collection engine 150 or any other component of the meeting narration application 140.

In some embodiments, prior to displaying a visualization within the meeting narration GUI 192, the GUI engine 190 can automatically augment the visualization with any number and/or types of graphical widgets (e.g., scroll bars and re-sizing mechanisms) in any technically feasible fashion. In the same or other embodiments, at any given time, the GUI engine 190 can determine and/or adjust the extent of visible portion(s) of each visualization displayed within the meeting narration GUI 192 in any technically feasible fashion.

In some embodiments, the GUI engine 190 can organize the set of visualizations within the meeting narration GUI 192 in any technically feasible fashion. In the same or other embodiments, the GUI engine 190 can perform any number and/or types of operations to ensure that the display of the set of visualizations within the meeting narration GUI 192 reflect any modifications to the set of visualizations. In some embodiments, in response to receiving one or more visualizations from the topic engine 182, the attendee engine 184, the timeline engine 186, the content engine 188, or any combination thereof, the GUI engine 190 can display, re-display, and/or cease to display any number of visualizations within the meeting narration GUI 192.

Note that the techniques described herein are illustrative rather than restrictive and can be altered without departing from the broader spirit and scope of the invention. Many modifications and variations on the functionality of the meeting preprocessing application 120, the meeting narration application 140, the collection engine 150, the topic engine 182, the attendee engine 184, the timeline engine 186, the content engine 188, and the GUI engine 190 as described herein and/or the set of visualizations will be apparent to those of ordinary skill in the art without departing from the scope and spirit of the described embodiments.

For instance, in some embodiments, the meeting preprocessing application 120 generates optimized datasets 132 that each include, without limitation, a set of animated images and/or a set of video clips instead of or in addition to a thumbnail set. In the same or other embodiments, the content engine 188 generates expanded content visualizations that each include an animated image and/or a video clip instead of or in addition to a thumbnail image and/or a sound bite.

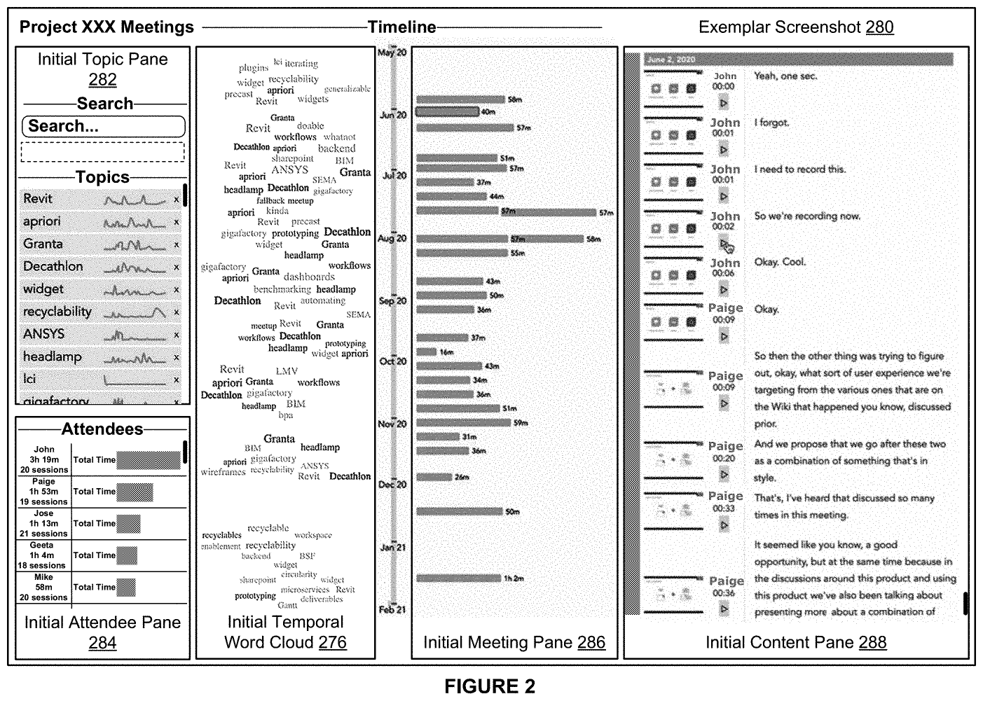

FIG. 2 is an illustration of an exemplar screenshot 280 of an initial set of visualizations generated by the meeting narration application 140 of FIG. 1, according to various embodiments. As described previously herein in conjunction with FIG. 1, in some embodiments, the meeting narration application 140 generates the initial set of visualizations based on an initial state corresponding to the topic selection 172 of no topics, the attendee selection 174 of no attendees, and the meeting selection 176 of the most recent meeting included in the meeting list 152. In the same or other embodiments, the meeting narration application 140 displays the initial set of visualizations within the meeting narration GUI 192. As shown, in some embodiments, the initial set of visualizations includes, without limitation, an initial topic pane 282, an initial attendee pane 284, a timeline, an initial temporal word cloud 276, an initial meeting pane 286, and an initial content pane 288.

In some embodiments, the initial topic pane 282 includes, without limitation, a search sub-pane and a sparkline sub-pane. The search sub-pane allows a user to select any number of the topics depicted in the sparkline sub-pane, allows the user to specify and select any number of new topics, and depicts that no topic is selected. For each topic, the sparkline sub-pane includes, without limitation, a sparkline indicating the relative prevalence of the topic with respect to the meeting collection over time. Note that only the top portion of the sparkline sub-pane is visible in FIG. 2. Because the sparklines are ordered based on the relative frequencies with which the corresponding topics occur in the transcript sentences, FIG. 2 depicts a subset of the nine topics that were discussed most frequently over the meeting collection.

As shown, in some embodiments the initial attendee pane 284 is an interactive bar chart that specifies a different uncolored bar for each attendee and allows a user to select at most one attendee at any given time. Because no attendees are selected, the relative length of each bar corresponds to the total speaking time of the corresponding attendees and the bars are ordered based on the length of the bars.

As described previously herein, in some embodiments, the initial temporal word cloud 276 depicts topics that are prominent in the transcript sentences during periods of time that are aligned to the visualization of the timeline. Because no topics are selected, the topics in the initial temporal word cloud 276 are depicted in greyscale. The shade and size with which each topic is depicted correlates to the frequency of the topic during the associated period of time.

In some embodiments, the initial meeting pane 286 is an interactive bar chart that specifies a different bar for each meeting and allows a user to select any number of the meetings. In some embodiments, the position of each bar is aligned to the timeline based on the time span of the corresponding meeting. In the same or other embodiments, the length of each bar indicates the transcript length of the corresponding meeting.

In some embodiments, the initial content pane 288 includes, without limitation, an expanded content visualization for each transcript sentence included in the most recent meeting in the meeting collection. FIG. 2 depicts a visible subset of the expanded content visualizations. As shown, each of the expanded content visualizations includes, without limitation, a textual representation of the corresponding transcript sentence, a textual representation of the name of the corresponding speaker, a textual representation of a corresponding timestamp, a corresponding thumbnail image, and a playback widget that is associated with a corresponding sound bite.

Notably, as FIG. 2 depicts, collectively the initial topic pane 282, the initial attendee pane 284, the timeline, the initial temporal word cloud 276, and the initial meeting pane 286 provide an overview of the attendees and the topics, highlighting relevant patterns, trends and relationships across the meeting collection. FIG. 2 also provides an unfiltered view of the most recent meeting in the meeting collection.

### Interactively Targeting Meeting Content

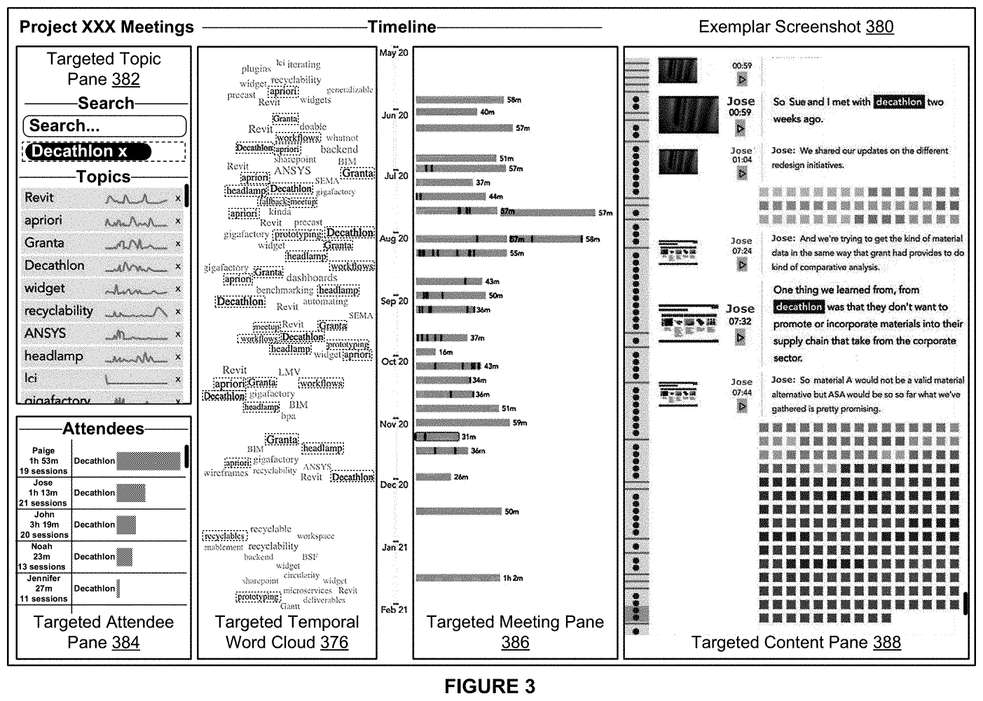

FIG. 3 is an illustration of an exemplar screenshot 380 of a targeted set of visualizations generated by the meeting narration application 140 of FIG. 1, according to various embodiments. For explanatory purposes, in some embodiments, the meeting narration application 140 generates the targeted set of visualizations based on targeted state corresponding to the topic selection 172 of “Decathlon” and the attendee selection 174 of no attendees. In some embodiments, including the embodiment depicted in FIG. 3, because a target topic is specified, the meeting narration application 140 does not take the meeting selection 176 into account when generating the targeted set of visualizations. In the same or other embodiments, the meeting narration application 140 displays the targeted set of visualizations within the meeting narration GUI 192.

As shown, in some embodiments, the targeted set of visualizations includes, without limitation, a targeted topic pane 382, a targeted attendee pane 384, a timeline, a targeted temporal word cloud 376, a targeted meeting pane 386, and a targeted content pane 388. For explanatory purposes, the targeted set of visualizations are described relative to the initial set of visualizations depicted in the exemplar screenshot 280 of FIG. 2.

In some embodiments, relative to the initial topic pane 282 of FIG. 2, a search sub-pane included in the targeted topic pane 382 depicts that the topic “Decathlon” is selected, and the remainder of the targeted topic pane 382 is the same. Although colors are not shown in FIG. 2, in some embodiments, the search sub-pane depicts the topic “Decathlon” in blue.

Relative to the initial attendee pane 284 of FIG. 2, for each of the attendees, the targeted attendee pane 384 depicts the speaking time on the topic “Decathlon” instead of the total speaking time across the meeting collection. Furthermore, the bars within the targeted attendee pane 384 are ordered based on the speaking times on the topic “Decathlon” instead of the total speaking times. Although colors are not shown in FIG. 2, the bars within the targeted attendee pane 384 are colored blue.

For explanatory purposes, topics in the targeted temporal word cloud 376 that are shades of blue are depicted as enclosed within dashed boxes. In some embodiments, relative to the initial temporal word cloud 276 of FIG. 2, the topic “Decathlon” and the co-occurring terms “apriori,” “Grants,” “workflows,” “headlamp,” “fallback,” “meetup,” and “prototyping” are depicted in shades of blue in the targeted temporal word cloud 376 and the remaining aspects of the targeted temporal word cloud 376 are the same. targeted

In some embodiments, relative to the initial meeting pane 286 of FIG. 2, blue-colored strips (depicted in FIG. 2 as dark strips) are superimposed over the bars included in the targeted meeting pane 386 and the remainder of the targeted meeting pane 386 is the same. Notably, the blue-colored strips denote occurrences of the topic “Decathlon” within the meetings.

In some embodiments, the targeted content pane 388 includes, without limitation, an expanded content visualization for each related transcript sentence in the meeting collection, a reduced-size expanded content visualization for each contextual transcript sentence in the meeting collection, and a compressed content visualization for each unrelated transcript sentence. Although colors are not shown in FIG. 2, in some embodiments, occurrences of the topic “Decathlon” and the corresponding inflections are colored blue in the expanded content visualizations. Furthermore, an overview scroll bar is annotated with small colored dots to indicate occurrences of the topic “Decathlon” and corresponding inflections across the meeting collection.

Advantageously, as illustrated in FIGS. 2 and 3, because the meeting narration application 140 automatically emphasizes meeting content that is likely to be relevant to user selections of topics and/or attendees and filters-out remaining meeting content, meeting content for even large collections of meetings can be efficiently explored. Furthermore, for each related transcript sentence, the corresponding contextual transcript sentences and playback widget enable efficient resolution of any transcription errors. Augmenting the visualizations of meeting content with visualizations of relevant analytical information (e.g., sparklines, bar charts, and the temporal word cloud) can highlight relevant patterns, trends, and relationships across the meeting collection that can lead to useful insights. For example, the meeting narration application 140 can automatically illustrate trends in the topics and/or attendees over time. In another example, the meeting narration application 140 can provide insight into the experience levels of attendees with respect to topics. In yet another example, the meeting narration application 140 can visually depict unexpected relationships and correlations between topics and/or attendees.

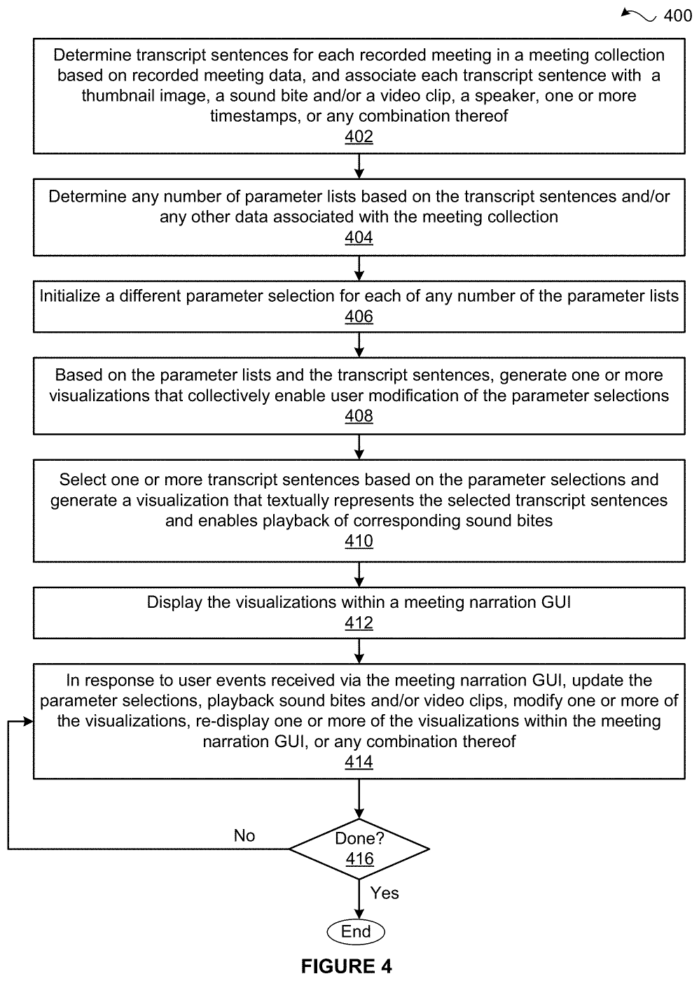

FIG. 4 is a flow diagram of method steps for generating visualizations of recorded meeting data, according to various embodiments. Although the method steps are described with reference to the systems of FIGS. 1-3, persons skilled in the art will understand that any system configured to implement the method steps, in any order, falls within the scope of the present invention.

As shown, a method 400 begins at step 402, where the meeting preprocessing application 120 determines transcript sentences for each recorded meeting in a meeting collection based on recorded media data (e.g., recorded meeting datasets 102(1)-102(N)) and associates each transcript sentence with a thumbnail image, a sound bite and/or a video clip, a speaker, one or more timestamps, or any combination thereof. At step 404, the meeting narration application 140 determines each of any number of parameter lists (e.g., the topic list 154 and the attendee list 156) based on the transcript sentences and/or any other data associated with the meeting collection. At step 406, the meeting narration application 140 initializes a different parameter selection for each of any number of the parameter lists.

At step 408, based on the parameter lists and the transcript sentences, the meeting narration application 140 generates one or more visualizations that collectively enable user modification of the parameter selections. At step 410, the meeting narration application 140 selects one or more transcript sentences based on the parameter selections and generates a visualization that textually represents the selected transcript sentences and enables playback of corresponding sound bites.

At step 412, the meeting narration application 140 displays the visualizations within the meeting narration GUI 192. At step 414, in response to user events received via the meeting narration GUI 192, the meeting narration application 140 updates the parameter selections, plays back sound bites and/or video clips, modifies one or more of the visualizations, re-displays one or more of the visualizations within the meeting narration GUI 192, or any combination thereof.

At step 416, the meeting narration application 140 determines whether the exploration of the meeting collection is done. If, at step 416, the meeting narration application 140 determines that the exploration of the meeting collection is not done, then the method 400 returns to step 414, where the meeting narration application 140 responds to user events received via the meeting narration GUI 192.

If, however, at step 416, the meeting narration application 140 determines that the exploration of the meeting collection is not done, then the method 400 terminates.

In sum, the disclosed techniques enable efficient visual navigation of recorded meeting content and derived information for meeting collections. In some embodiments, for each recorded meeting in a meeting collection, a meeting preprocessing application generates an optimized dataset based on an audio-visual recording and a transcript of the recorded meeting. Each optimized dataset includes, without limitation, time-stamped thumbnails, time-stamped sound bites, and time-stamped transcript sentences. Each time-stamped transcript sentence is associated with one of the thumbnail images, one of the sound bites, and the corresponding speaker (one of the meeting attendees).

In the same or other embodiments, a meeting narration application determines a list of topics that are likely to be important to the collection of meetings and a list of attendees based on the optimized datasets. The meeting narration application initializes state data to specify that no topics are selected, not attendees are selected, and the most recent meeting is selected. Based on the optimized datasets, the topics, the attendees, and the state data, the meeting narration application generates a set of visualizations and displays the set of visualizations within a meeting narration GUI that is displayed on a display screen. Collectively, the visualizations included in the set of visualizations enable interactive systematic per-sentence exploration of the recorded meeting data and derived information data based on topic, attendee, meeting, or any combination thereof.

More specifically, the set of visualizations collectively allows the user to select and/or deselect any number of topics, a target attendee, and any number of meetings. In response to each change in the user selections, the meeting narration application updates the state data, updates one or more of the visualizations in the set of visualizations to reflect the state data, and re-display the updated visualizations within the meeting narration GUI. Importantly, the updated visualizations emphasize meeting content and derived information that is related to the user selections. In particular, the meeting narration application can modify the set of visualizations to expand visualizations of transcript sentences that are related to the user selections, provide on-demand playback of corresponding sound bites, collapse visualizations of transcript sentences that are unrelated to the user selections, visually depict relevant contextual data, and visually depict patterns, trends, and relationships associated with the user selections.

At least one technical advantage of the disclosed techniques relative to the prior art is that the disclosed techniques enable efficient exploration and analysis of recorded meeting content based on topics, attendees, or other similar parameters. In that regard, with the disclosed techniques, visualizations of transcript sentences displayed within a GUI can be automatically collapsed or expanded based on topic selection, attendee selection, or other parameter selection to interactively filter-out transcript sentences that likely are irrelevant. Further, with the disclosed techniques, because graphical widgets associated with expanded visualizations of transcript sentences enable on-demand playback of corresponding sound bites, ambiguities arising from transcription errors can be efficiently resolved. Another advantage of the disclosed techniques is that visualizations displayed within a GUI can automatically expose potentially relevant patterns and trends across any volume and/or type of media content. These technical advantages provide one or more technological improvements over prior art approaches.

1. In some embodiments, a computer-implemented method for generating visualizations of recorded meeting data comprises generating a first visualization of a plurality of parameters based on a plurality of transcript sentences associated with the recorded meeting data; displaying the first visualization and a first expanded content visualization of a first transcript sentence included in the plurality of transcript sentences within a graphical user interface (GUI); receiving a user event associated with the first visualization via the GUI; modifying a first parameter selection associated with the plurality of parameters based on the user event to generate a modified parameter selection; and displaying a first compressed content visualization of the first transcript sentence within the GUI based on the modified parameter selection.

2. The computer-implemented method of clause 1, wherein the plurality of parameters comprises a plurality of attendees or a plurality of topics.

3. The computer-implemented method of clauses 1 or 2, wherein the plurality of parameters comprises a plurality of topics, and further comprising computing a plurality of frequencies of a plurality of terms occurring in the plurality of transcript sentences to determine the plurality of topics.

4. The computer-implemented method of any of clauses 1-3, wherein the plurality of parameters comprises a plurality of topics, and wherein generating the first visualization comprises generating a plurality of charts based on the plurality of topics and the plurality of transcript sentences, wherein each chart included in the plurality of charts depicts a prevalence of a different topic included in the plurality of topics over a period of time associated with the recorded meeting data.

5. The computer-implemented method of any of clauses 1-4, wherein the plurality of parameters comprises a plurality of attendees, and wherein generating the first visualization comprises computing a plurality of speaking times based on the plurality of attendees and the plurality of transcript sentences; and generating at least one chart based on the plurality of speaking times.

6. The computer-implemented method of any of clauses 1-5, further comprising executing at least one of a word normalization algorithm or a text normalization algorithm on at least a second transcript sentence included in the plurality of transcript sentences to determine that the second transcript sentence includes an inflection of a topic specified in the modified parameter selection; and displaying a second expanded content visualization of the second transcript sentence within the GUI.

7. The computer-implemented method of any of clauses 1-6, further comprising determining that a second transcript sentence included in the plurality of transcript sentences was spoken by an attendee specified in the modified parameter selection; and displaying a second expanded content visualization of the second transcript sentence within the GUI.

8. The computer-implemented method of any of clauses 1-7, wherein the first expanded content visualization comprises at least one of a textual representation of the first transcript sentence, a representation of a speaker associated with the first transcript sentence, a thumbnail image that is temporally associated with the first transcript sentence, or a graphical widget that enables playback of at least one of a sound bite or a video clip corresponding to the first transcript sentence.

9. The computer-implemented method of any of clauses 1-8, further comprising, prior to receiving the user event generating a temporal word cloud based on a plurality of topics associated with the recorded meeting data and the plurality of transcript sentences; and displaying the temporal word cloud within the GUI.

10. The computer-implemented method of any of clauses 1-9, wherein the recorded meeting data is associated with a plurality of meetings, and further comprising modifying a second visualization of the plurality of meetings that is displayed within the GUI based on the modified parameter selection and the plurality of transcript sentences to generate a modified second visualization; and displaying the modified second visualization within the GUI.

11. In some embodiments, or more non-transitory computer readable media include instructions that, when executed by one or more processors, cause the one or more processors to generate visualizations of recorded meeting data by performing the steps of generating a first visualization of a plurality of parameters based on a plurality of transcript sentences associated with the recorded meeting data; displaying the first visualization and a first expanded content visualization of a first transcript sentence included in the plurality of transcript sentences within a graphical user interface (GUI); receiving a user event associated with the first visualization via the GUI; modifying a first parameter selection associated with the plurality of parameters based on the user event to generate a modified parameter selection; and displaying a first compressed content visualization of the first transcript sentence within the GUI based on the modified parameter selection.

12. The one or more non-transitory computer readable media of clause 11, wherein the modified parameter selection specifies a subset of a plurality of topics or a subset of a plurality of attendees.

13. The one or more non-transitory computer readable media of clauses 11 or 12, wherein the plurality of parameters comprises a plurality of topics, and further comprising computing a plurality of frequencies of a plurality of terms occurring in the plurality of transcript sentences to determine the plurality of topics.

14. The one or more non-transitory computer readable media of any of clauses 11-13, wherein the plurality of parameters comprises a plurality of topics, and wherein generating the first visualization comprises generating a plurality of charts based on the plurality of topics and the plurality of transcript sentences, wherein each chart included in the plurality of charts depicts a prevalence of a different topic included in the plurality of topics over a period of time associated with the recorded meeting data.

15. The one or more non-transitory computer readable media of any of clauses 11-14, wherein the plurality of parameters comprises a plurality of topics, the modified parameter selection specifies a subset of the plurality of topics, and further comprising computing a plurality of per-topic speaking times based on a plurality of attendees, the subset of the plurality of topics, and the plurality of transcript sentences; and displaying a second visualization that depicts the plurality of per-topic speaking times within the GUI.

16. The one or more non-transitory computer readable media of any of clauses 11-15, further comprising executing at least one of a word normalization algorithm or a text normalization algorithm on at least a second transcript sentence included in the plurality of transcript sentences to determine that the second transcript sentence is not associated with the modified parameter selection; and displaying a second compressed content visualization of the second transcript sentence within the GUI.

17. The one or more non-transitory computer readable media of any of clauses 11-16, further comprising determining that a second transcript sentence included in the plurality of transcript sentences was spoken by an attendee specified in the modified parameter selection; and displaying a second expanded content visualization of the second transcript sentence within the GUI.

18. The one or more non-transitory computer readable media of any of clauses 11-17, further comprising generating a plurality of compressed content visualizations based on a plurality of audio-video recordings included the recorded meeting data; and identifying the first compressed content visualization from the plurality of compressed content visualizations based on a first timestamp associated with the first transcript sentence.

19. The one or more non-transitory computer readable media of any of clauses 11-18, further comprising modifying a temporal word cloud that is displayed within the GUI based on the modified parameter selection to generate a modified temporal word cloud; and displaying the modified temporal word cloud within the GUI.

20. In some embodiments, a system comprises one or more memories storing instructions; and one or more processors coupled to the one or more memories that, when executing the instructions, perform the steps of generating a first visualization of a plurality of parameters based on a plurality of transcript sentences associated with recorded meeting data; displaying the first visualization and a first expanded content visualization of a first transcript sentence included in the plurality of transcript sentences within a graphical user interface (GUI); receiving a user event associated with the first visualization via the GUI; modifying a first parameter selection associated with the plurality of parameters based on the user event to generate a modified parameter selection; and displaying a first compressed content visualization of the first transcript sentence within the GUI based on the modified parameter selection.

Any and all combinations of any of the claim elements recited in any of the claims and/or any elements described in this application, in any fashion, fall within the contemplated scope of the embodiments and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. Aspects of the present embodiments can be embodied as a system, method, or computer program product. Accordingly, aspects of the present disclosure can take the form of an entirely hardware embodiment, an entirely software embodiment (including firmware, resident software, and micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable media having computer readable program codec embodied thereon.

Any combination of one or more computer readable media can be utilized. Each computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory, a read-only memory, an erasable programmable read-only memory, a Flash memory, an optical fiber, a portable compact disc read-only memory, an optical storage device, a magnetic storage device, or any suitable combination of the foregoing. In the context of this document, a computer readable storage medium can be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method for generating visualizations of recorded meeting data, the method comprising:
generating a first visualization of a plurality of parameters based on a plurality of transcript sentences associated with the recorded meeting data;
displaying the first visualization and a first expanded content visualization of a first transcript sentence included in the plurality of transcript sentences within a graphical user interface (GUI);
receiving a user event associated with the first visualization via the GUI;
modifying a first parameter selection associated with the plurality of parameters based on the user event to generate a modified parameter selection; and
displaying a first compressed content visualization of the first transcript sentence within the GUI based on the modified parameter selection.

2. The computer-implemented method of claim 1, wherein the plurality of parameters comprises a plurality of attendees or a plurality of topics.

3. The computer-implemented method of claim 1, wherein the plurality of parameters comprises a plurality of topics, and further comprising computing a plurality of frequencies of a plurality of terms occurring in the plurality of transcript sentences to determine the plurality of topics.

4. The computer-implemented method of claim 1, wherein the plurality of parameters comprises a plurality of topics, and wherein generating the first visualization comprises generating a plurality of charts based on the plurality of topics and the plurality of transcript sentences, wherein each chart included in the plurality of charts depicts a prevalence of a different topic included in the plurality of topics over a period of time associated with the recorded meeting data.

5. The computer-implemented method of claim 1, wherein the plurality of parameters comprises a plurality of attendees, and wherein generating the first visualization comprises:
computing a plurality of speaking times based on the plurality of attendees and the plurality of transcript sentences; and
generating at least one chart based on the plurality of speaking times.

6. The computer-implemented method of claim 1, further comprising:
executing at least one of a word normalization algorithm or a text normalization algorithm on at least a second transcript sentence included in the plurality of transcript sentences to determine that the second transcript sentence includes an inflection of a topic specified in the modified parameter selection; and
displaying a second expanded content visualization of the second transcript sentence within the GUI.

7. The computer-implemented method of claim 1, further comprising:
determining that a second transcript sentence included in the plurality of transcript sentences was spoken by an attendee specified in the modified parameter selection; and
displaying a second expanded content visualization of the second transcript sentence within the GUI.

8. The computer-implemented method of claim 1, wherein the first expanded content visualization comprises at least one of a textual representation of the first transcript sentence, a representation of a speaker associated with the first transcript sentence, a thumbnail image that is temporally associated with the first transcript sentence, or a graphical widget that enables playback of at least one of a sound bite or a video clip corresponding to the first transcript sentence.

9. The computer-implemented method of claim 1, further comprising, prior to receiving the user event:
generating a temporal word cloud based on a plurality of topics associated with the recorded meeting data and the plurality of transcript sentences; and
displaying the temporal word cloud within the GUI.

10. The computer-implemented method of claim 1, wherein the recorded meeting data is associated with a plurality of meetings, and further comprising:
modifying a second visualization of the plurality of meetings that is displayed within the GUI based on the modified parameter selection and the plurality of transcript sentences to generate a modified second visualization; and
displaying the modified second visualization within the GUI.

11. One or more non-transitory computer readable media including instructions that, when executed by one or more processors, cause the one or more processors to generate visualizations of recorded meeting data by performing the steps of:
generating a first visualization of a plurality of parameters based on a plurality of transcript sentences associated with the recorded meeting data;
displaying the first visualization and a first expanded content visualization of a first transcript sentence included in the plurality of transcript sentences within a graphical user interface (GUI);
receiving a user event associated with the first visualization via the GUI;
modifying a first parameter selection associated with the plurality of parameters based on the user event to generate a modified parameter selection; and
displaying a first compressed content visualization of the first transcript sentence within the GUI based on the modified parameter selection.

12. The one or more non-transitory computer readable media of claim 11, wherein the modified parameter selection specifies a subset of a plurality of topics or a subset of a plurality of attendees.

13. The one or more non-transitory computer readable media of claim 11, wherein the plurality of parameters comprises a plurality of topics, and further comprising computing a plurality of frequencies of a plurality of terms occurring in the plurality of transcript sentences to determine the plurality of topics.

14. The one or more non-transitory computer readable media of claim 11, wherein the plurality of parameters comprises a plurality of topics, and wherein generating the first visualization comprises generating a plurality of charts based on the plurality of topics and the plurality of transcript sentences, wherein each chart included in the plurality of charts depicts a prevalence of a different topic included in the plurality of topics over a period of time associated with the recorded meeting data.

15. The one or more non-transitory computer readable media of claim 11, wherein the plurality of parameters comprises a plurality of topics, the modified parameter selection specifies a subset of the plurality of topics, and further comprising:
computing a plurality of per-topic speaking times based on a plurality of attendees, the subset of the plurality of topics, and the plurality of transcript sentences; and
displaying a second visualization that depicts the plurality of per-topic speaking times within the GUI.

16. The one or more non-transitory computer readable media of claim 11, further comprising:
executing at least one of a word normalization algorithm or a text normalization algorithm on at least a second transcript sentence included in the plurality of transcript sentences to determine that the second transcript sentence is not associated with the modified parameter selection; and
displaying a second compressed content visualization of the second transcript sentence within the GUI.

17. The one or more non-transitory computer readable media of claim 11, further comprising:
determining that a second transcript sentence included in the plurality of transcript sentences was spoken by an attendee specified in the modified parameter selection; and
displaying a second expanded content visualization of the second transcript sentence within the GUI.

18. The one or more non-transitory computer readable media of claim 11, further comprising:
generating a plurality of compressed content visualizations based on a plurality of audio-video recordings included the recorded meeting data; and
identifying the first compressed content visualization from the plurality of compressed content visualizations based on a first timestamp associated with the first transcript sentence.

19. The one or more non-transitory computer readable media of claim 11, further comprising:
modifying a temporal word cloud that is displayed within the GUI based on the modified parameter selection to generate a modified temporal word cloud; and
displaying the modified temporal word cloud within the GUI.

20. A system comprising:
one or more memories storing instructions; and
one or more processors coupled to the one or more memories that, when executing the instructions, perform the steps of:
generating a first visualization of a plurality of parameters based on a plurality of transcript sentences associated with recorded meeting data;
displaying the first visualization and a first expanded content visualization of a first transcript sentence included in the plurality of transcript sentences within a graphical user interface (GUI);
receiving a user event associated with the first visualization via the GUI;
modifying a first parameter selection associated with the plurality of parameters based on the user event to generate a modified parameter selection; and
displaying a first compressed content visualization of the first transcript sentence within the GUI based on the modified parameter selection.
